(19) United States
(12) Patent Application Publication
(10) Pub. No.: US 2014/0200994 A1
(43) Pub. Date: Jul. 17, 2014

(54) ELECTRONIC PLATFORM BASED ON COMPUTER NETWORK

(71) Applicants: Andrea Carignani, Milano (IT); Giulio Canti, Milano (IT); Giuseppe Moscarella, Pieve Emanuele (IT); Lorenzo Negri, Castelmassa (IT); Alberto Romano, Milano (IT)

(72) Inventors: Andrea Carignani, Milano (IT); Giulio Canti, Milano (IT); Giuseppe Moscarella, Pieve Emanuele (IT); Lorenzo Negri, Castelmassa (IT); Alberto Romano, Milano (IT)

(73) Assignees: ANDREA CARIGNANI; GIULIO CANTI; ALBERTO ROMANO; LORENZO NEGRI; GIUSEPPE MOSCARELLA

(21) Appl. No.: 14/232,500

(22) PCT Filed: Jul. 13, 2012
(86) PCT No.: PCT/IB2012/053609

§ 371 Date: Mar. 26, 2014

(30) Foreign Application Priority Data
Jul. 14, 2011 (IT) RM2011A000366

(51) Int. Cl. G06Q 30/02

(52) U.S. Cl. CPC G06Q 30/0246
USPC 705/14.45

(57) ABSTRACT

This invention relates to a computer network system, as well as to the instruments and apparatuses allowing the execution of the related methods of operation, comprising a main server computer (10) connected to a communication network (20) to which a CDN (Content Delivery Network) sub-system (70) of server computers is also connected for delivering multimedia contents, and a plurality of user client devices (40, 50, 60) capable to connect to the communication network (20), each user client device (40, 50, 60) being adapted to execute a browser software module (400) comprising temporary storage or caching mechanisms, the browser software module (400) being adapted to connect with a first interface software module (100) executed by the main server computer (10) for visiting a web site of a promotional campaign comprising one or more interactive graphic interfaces (3100; 3200), each interactive graphic interface comprising static data including said multimedia contents, one or more graphic elements (3210; 3230) each one of which is capable to stimulate users by delivering said multimedia contents, and one or more graphic components (4200) capable to receive interactions from the users, at least one product being offered by said at least one web site of said at least one promotional campaign at a price that is reduced starting from a starting price after the interactions from the users on the basis of the processing of a price function processing software module (120) executed by the main server computer (10), the first interface software module (100) causing said static data to be delivered to the browser software module (400) by the CDN sub-system (70) and a rendering of said one or more interactive graphic interfaces (3100; 3200) to be carried out by the browser software module (400) through said caching mechanisms.

The present invention relates to an electronic platform based on a network of computers (in the following indicated also as computers, comprising server computers and client computers), including the related system based on a computer network and the related methods of operation, that allows in a technically reliable, versatile, fast, simple, and inexpensive, to make, execute and manage highly interactive campaigns of promotional sales on the Internet network.

The present invention also concerns the instruments and apparatuses being part of the platform and allowing the related methods of operation to be executed.

It is known that all types of promotional activities, in particular for sale promotion, are used by companies for supporting their own marketing strategies, such as for instance:
marketing researches, wherein the promoting company gets personal and qualified information about consumer clients through the offer of promotional goods or services, such as for instance company coupons or products;
opinion polls, wherein the promoting company gets widespread opinions of people through the offer of promotional goods or services to the participating ones;
distribution of free samples to try, wherein the promoting company gets a return on image and the promotion of the products related to the samples;
distribution of coupons for buying products or services, wherein the promoting company incentivizes the first purchase and the subsequent ones of such products or services, increasing the sales thereof;
prize draws, wherein the promoting company gets personal data of the participating clients/consumers and a prolonged attention by the clients/consumers to the product or service to which the prize draw is connected, by assigning free goods or services to the winners;
point collections and loyalty cards, wherein the promoting company gets consumer personal data and information about his/her purchasing behaviour, by assigning prizes or discounts;
prizes for amounts of purchases of the same product or service attested by proofs of purchase (this activity is also called Self Liquidating Premium), wherein the promoting company gets a customer loyalty to the product or service, also by assigning as prizes other products or services of the same company, thus obtaining a promotion also for the latter;
promotional activities for supporting humanitarian or charitable initiatives, wherein the promoting company gets a return on image by funding charity events (e.g. for collecting funds);
price reductions, through which the promoting company encourages a repurchase of the product or service improving its visibility.

Many promotional activities are also carried out on the Internet network, such as, for instance:
ascending bid auctions, wherein the promoting company gets a brand enhancement and revenues from the sale of products, possibly by offering products or services difficult to find through the traditional market, through a gratification of the user who wins the product or service;
Dutch auctions, wherein the promoting company gets a brand enhancement and revenues from the sale of products and from the payment of an entry fee for the auction, through a gratification of the user who wins the product or service (by means of the lowest offer that is also unique);
purchasing groups, wherein the promoting company gets a brand enhancement and reaches an increasingly wide catchment of consumers, offering more information on products and services, a significant save, and a sharing of experiences and opinions;
online outlet store, wherein the promoting company gets gains by selling brand products from past collections stored in a warehouse, by offering discounts;
affiliate programs, wherein the promoting company creates a selling network and increases the traffic towards its own site, thus obtaining an advertising over the Internet network and revenues on an entry or yearly fee, exploiting the possibility of tracking the advertising and directing the same to targeted users (e.g. on the basis of the interests declared by the latter), offering a generally low remuneration (e.g. discounts) with no need for a constant effort;
cashback sites, wherein the promoting company creates and keeps traffic on its own site securing the loyalty of the users, obtaining a higher inclination to purchase and hence a larger gain, offering money back for the purchase that is transformed into discounts for products or services to be purchased later.

Other promotional activities on the Internet network are carried out by exploiting new alternative channels of information and socialisation, such as the so-called Social Networks, forum sites, and so-called blogs.

However, all these promotional activities on the Internet network have some drawbacks, such as that of soliciting only a low and discontinuous interaction by the users and of requiring often complex and long governmental authorisations.

The low and discontinuous interaction by the users is due to the fact that such promotional activities are carried out on hardware and software platforms which do not allow a management of simultaneous interactions by a large number of users in a fast and reliable way without entailing an excessive bandwidth occupancy on the used communication networks. This entails that the presently existing platforms are based on the so-called push technology, wherein the interactions are started by the web site with which the users connect, i.e. significantly limiting the user's interaction. By way of example, also for obviating to the complexity of updating data related to the promotions (e.g. product prices during auction execution) in real time, presently available platforms display the prices in standard interfaces which cannot be modified by the user, with restrictions to the user's browser.

Moreover, presently available hardware and software platforms for the aforementioned promotional activities on the Internet network do not allow the promoting companies to simply and flexibly implement the same promotions on the network.

In fact, the main instruments of CMS (Content Management System) which are presently available, installed on the web servers, are oriented to the development of web sites, the structure of which is static, and to the (even dynamic) management of the related contents, and they are not suitable for the necessarily dynamic, simple and versatile implementation (as to the graphic proposal of the structure) of promotions.

Also, such CMS instruments are usually based on a set of predefined templates that the user may populate with customised contents, whereby the user's creativity in creating the pages is limited by the template superstructure and renders the so implemented promotions (as well as the web sites) not much versatile.

It is an object of this invention, therefore, to allow in a technically reliable, versatile, fast, simple, and inexpensive, way the implementation, execution, and management of promotional activities on the Internet network which are highly interactive for users.

It is specific subject-matter of the present invention a computer network system comprising a main server computer comprising first processing means, that is connected to a first communication network to which a CDN (Content Delivery Network) sub-system of server computers, connected to each other in a network, is also connected for delivering multimedia contents, and a plurality of user client devices, each one of which comprises second processing means and communication means for connecting to the first communication network, said second processing means of each one of said user client devices being adapted to execute a first browser software module for browsing a web site, comprising temporary storage or caching mechanisms, the system being characterised in that the first browser software module, when executed by said second processing means, is adapted to connect with a first interface software module executed by said first processing means for visiting at least one web site of at least one promotional campaign comprising one or more interactive graphic interfaces, each one of said one or more interactive graphic interfaces comprising static data including one or more of said multimedia contents, one or more graphic elements each capable to stimulate users by delivering at least one of said one or more multimedia contents, and one or more graphic components capable to receive one or more interactions from the users, at least one product being offered by said at least one web site of said at least one promotional campaign at a price that is reduced starting from a starting price after said one or more interactions by the users received by said one or more graphic components, the first interface software module causing said static data to be delivered to the first browser software module by the CDN sub-system and a rendering of said one or more interactive graphic interfaces to be carried out by the first browser software module through said caching mechanisms, said first processing means being adapted to execute a price function processing software module that processes a reduced price of said product on the basis of each one of said one or more interactions by the users received by said one or more graphic components.

Also according to the invention, the first browser software module may connect with the first interface software module through AJAX calls with protocols based on JSON format, said static data comprising data in JSON format, the CDN sub-system preferably delivering to the first interface software module JavaScript libraries used by the first interface software module when the latter is operating.

Still according to the invention, the communication network may comprise the Internet network, the network through which the server computers of the CDN sub-system are connected to each other being preferably the Internet network.

Furthermore according to the invention, each one of said user client devices may be selected from the group comprising computers, cellular telephones, smartphones and televisions.

Also according to the invention, the system may further comprises at least one device of at least one company promoting said at least one promotional campaign, said at least one device comprising third processing means and communication means for connecting to the first communication network, said at least one device being preferably a client computer, said first processing means being adapted to execute a second software module for implementing said one or more interactive graphic interfaces, preferably comprising drag and drop mechanisms, said third processing means being adapted to execute a control software module, adapted to connect with the second software module for implementing said one or more interactive graphic interfaces, the second software module preferably implementing each one of said one or more interactive graphic interfaces through the CSS (Cascading Style Sheets) language with which contents of said one or more interactive graphic interfaces are described, the static data of said one or more interactive graphic interfaces implemented by the control software module through the second software module being stored by the second software module, preferably in JSON format, within the CDN sub-system, the first interface software module keeping information related to retrieval of said static data of said interactive pages within the CDN sub-system, the CDN sub-system preferably delivering to the second software module JavaScript libraries used by the second software module when the latter is operating.

Still according to the invention, said second processing means of each one of said user client devices may be adapted to execute a second browser software module for creating user data that, when executed by said second processing means, is adapted to connect with the first interface software module for creating at least one profile of recorded user for at least one promotional campaign, said at least one profile preferably comprising authentication data, the first interface software module enabling the first browser software module to browse said at least one promotional campaign only if it recognises a profile of recorded user communicated by the first browser software module to the first interface software module, said second processing means of each one of said user client devices being preferably adapted to execute a third browser software module for consulting said at least one promotional campaign that, when executed by said second processing means, is adapted to connect with the first interface software module for displaying information related to said at least one promotional campaign.

It is further specific subject-matter of the present invention a main server computer for use in the computer network system described above, comprising first processing means and connected to a first communication network, said first processing means executing the first interface software module that, when a first browser software module executed by second processing means of a user client device connected to the first communication network connects to the first interface software module for visiting at least one web site of at least one promotional campaign comprising one or more interactive graphic interfaces, causes the static data of said one or more interactive graphic interfaces to be delivered to the first browser software module by the CDN sub-system and a rendering of said one or more interactive graphic interfaces to be carried out by the first browser software module through caching mechanisms, said first processing means being adapted to execute a price function processing software module that processes, on the basis of one or more interactions by the users received by one or more graphic components of said one or more interactive graphic interfaces, a reduced price of at least one product offered by said at least one web site of said at least one promotional campaign starting from a starting price. Also according to the invention, said first processing means may be adapted to execute a second software module for implementing said one or more interactive graphic interfaces, preferably comprising drag and drop mechanisms, when a control software module executed by third processing means of a device of at least one company promoting at least one promotional campaign connected to the first communication network connects to the second software module for implementing said one or more interactive graphic interfaces, the second software module preferably implementing each one of said one or more interactive graphic interfaces through the CSS (Cascading Style Sheets) language with which contents of said one or more interactive graphic interfaces are described, the static data of said one or more interactive graphic interfaces implemented by the control software module through the second software module being stored by the second software module, preferably in JSON format, within the CDN sub-system, the first interface software module keeping information related to retrieval of said static data of said interactive pages within the CDN sub-system, the CDN sub-system preferably delivering to the first interface software module JavaScript libraries used by the first interface software module when the latter is operating, the CDN sub-system preferably delivering to the second software module JavaScript libraries used by the second software module when the latter is operating.

It is also specific subject-matter of the present invention a method of operating the computer network system described above, wherein a main server computer and a CDN sub-system are connected to a first communication network, the method comprising the following steps:
A. at least one user client device connects to the first communication network,
B. said at least one user client device executes a first browser software module for browsing a web site, comprising caching mechanisms,
   the method being characterised in that it further comprises the following steps:
C. the main server computer executes a first interface software module,
D. the first browser software module connects to the first interface software module for visiting at least one web site of at least one promotional campaign comprising one or more interactive graphic interfaces, each one of said one or more interactive graphic interfaces comprising static data including one or more multimedia contents, one or more graphic elements each capable to stimulate users by delivering at least one of said one or more multimedia contents, and one or more graphic components capable to receive one or more interactions from the users, at least one product being offered by said at least one web site of said at least one promotional campaign,
E. the first interface software module causes the CDN sub-system to deliver said static data to the first browser software module,
F. the first interface software module causes the first browser software module to carry out a rendering of said one or more interactive graphic interfaces through said caching mechanisms,
G. the main server computer executes a price function processing software module that processes a reduced price of said product starting from a starting price on the basis of each one of said one or more interactions by the users received by said one or more graphic components.

Also according to the invention, the method may further comprise the following steps:
H. at least one device of at least one company promoting said at least one promotional campaign connects to the first communication network,
I. said at least one device executes a control software module,
J. the main server computer executes a second software module for implementing said one or more interactive graphic interfaces, preferably comprising drag and drop mechanisms, said one or more interactive graphic interfaces being preferably implemented through the CSS (Cascading Style Sheets) language with which contents of said one or more interactive graphic interfaces are described,
K. the control software module connects to the second software module for implementing said one or more interactive graphic interfaces,
L. the second software module stores the static data, preferably in JSON format, of said one or more interactive graphic interfaces implemented by the control software module through the second software module within the CDN sub-system,
M. the first interface software module keeps information related to retrieval of said static data of said interactive pages within the CDN sub-system.

It is still specific subject-matter of the present invention a computer program, and the computer-readable memory medium on which it is stored, comprising code means adapted to perform, when operating on first processing means of a main server computer, the first interface software module of the method of operating the computer network system previously described.

It is also specific subject-matter of the present invention a computer program, and the computer-readable memory medium on which it is stored, comprising code means adapted to perform, when operating on first processing means of a main server computer, the second software module for implementing one or more interactive graphic interfaces of the method of operating the computer network system previously described.

It is still specific subject-matter of the present invention a computer program, and the computer-readable memory medium on which it is stored, comprising code means adapted to perform, when operating on third processing means of a device of at least one company promoting said at least one promotional campaign, the control software module of the method of operating the computer network system previously described.

The electronic platform based on computer network according to the invention allows the companies to design and implement highly interactive campaigns of promotional sales offering progressive discounts on the price of a product upon execution of one or more actions by one or more users.

In other words, the electronic platform according to the invention allows a promoting company to remunerate a work and/or a commitment of a single consumer of a plurality of consumers participating to a promotional activity on the Internet network through a redistribution in real time of the value of the work of such consumer to apply to the price of a particular product or service offered on promotional sale by the company.

Moreover, the electronic platform according to the invention permits a dynamic, simple and versatile implementation of promotions through an instrument allowing the free and easy insertion of sophisticated components stimulating the interaction of the users, such as multiple choice questionnaires, complex surveys and the like.

The present invention will be now described by way of illustration, not by way of limitation, according to its preferred embodiments, by particularly referring to the Figures of the annexed drawings, in which:

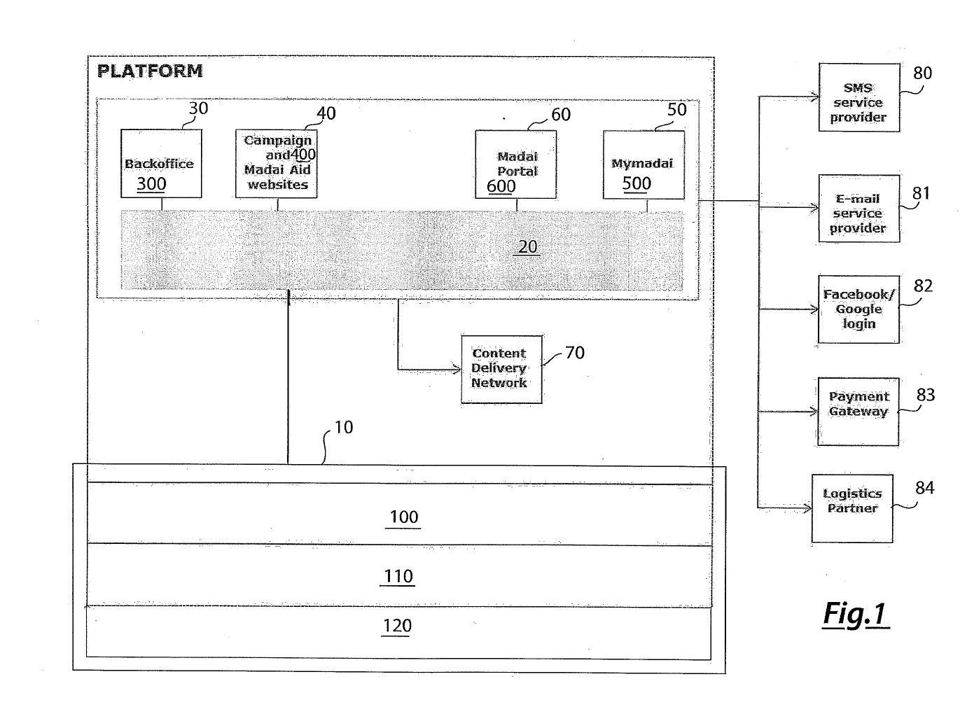

FIG. 1 schematically shows a preferred embodiment of the computer network system according to the invention;

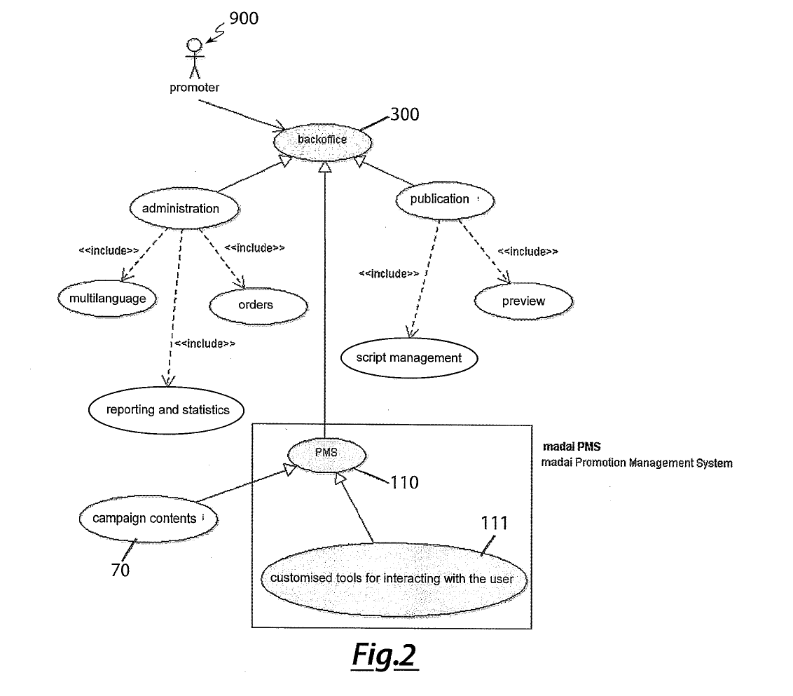

FIG. 2 shows a block diagram schematically illustrating the interactions among software modules executed by the system of FIG. 1;

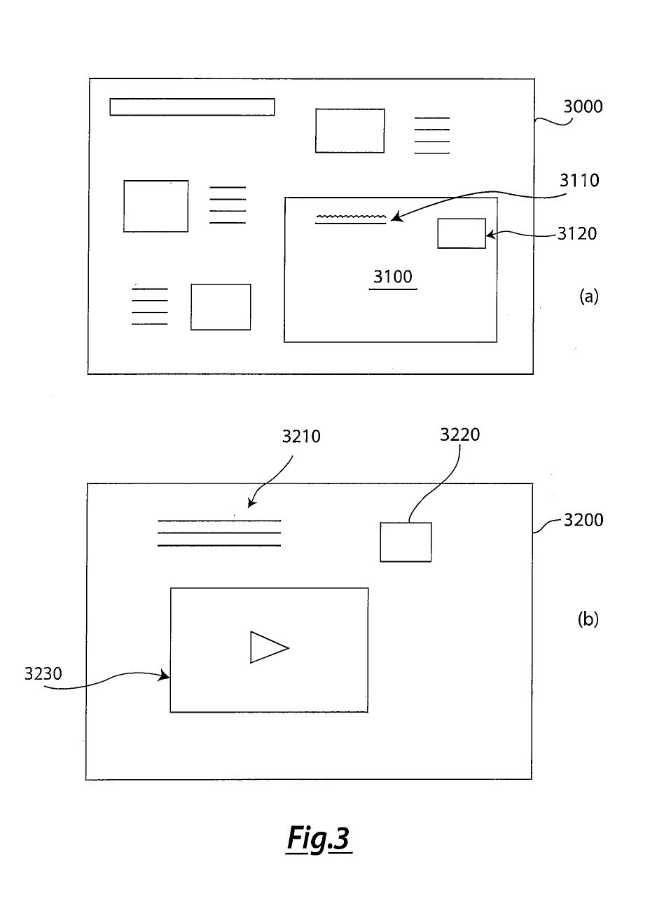

FIG. 3 schematically shows an initial graphic interface (FIG. 3a) and a subsequent graphic interface (FIG. 3b) employed in the system of FIG. 1;

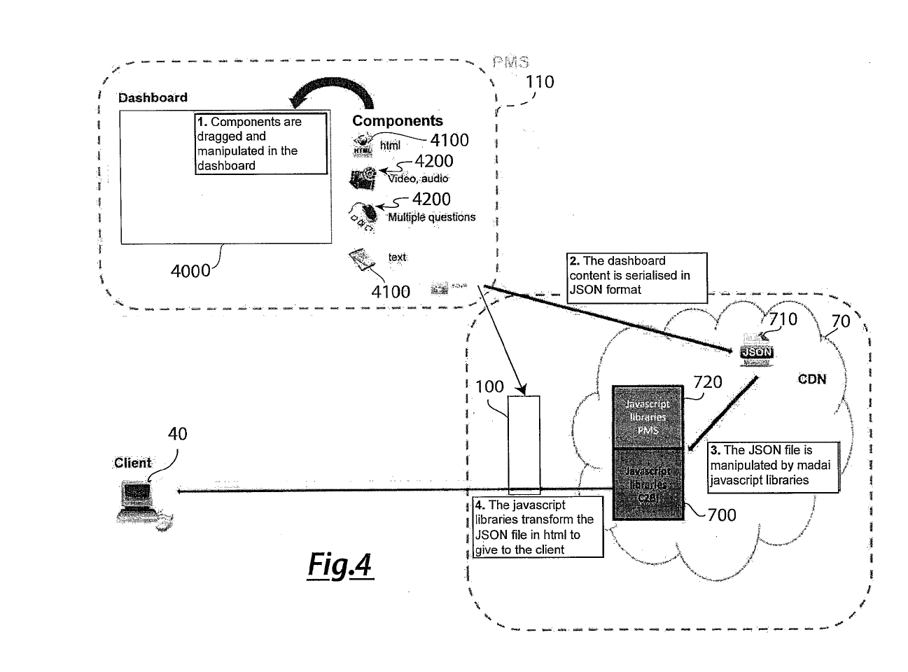

FIG. 4 shows a block diagram schematically illustrating the operation of two further software modules executed by the system of FIG. 1;

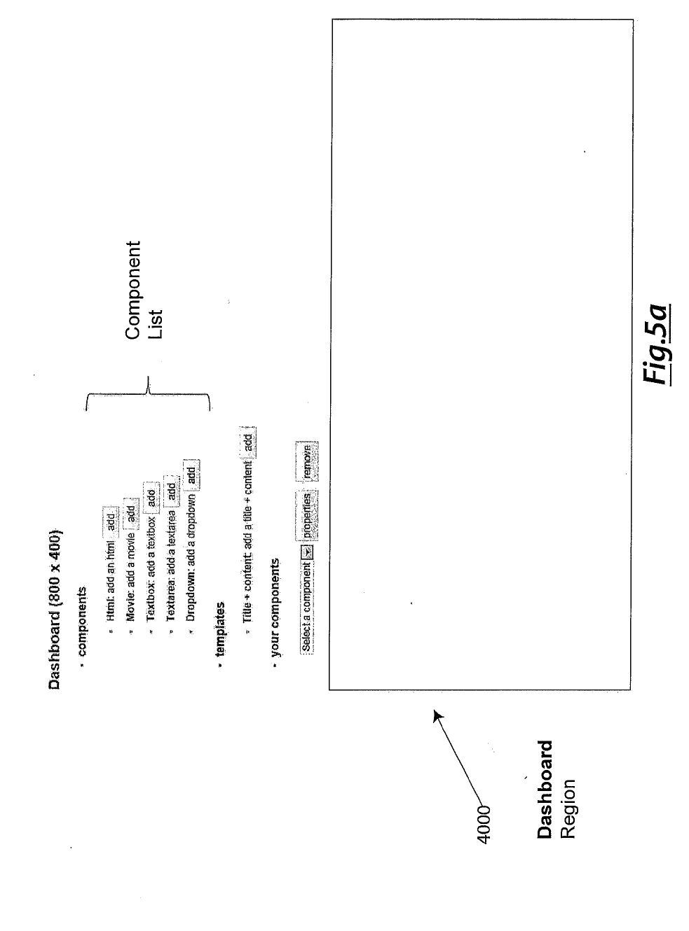

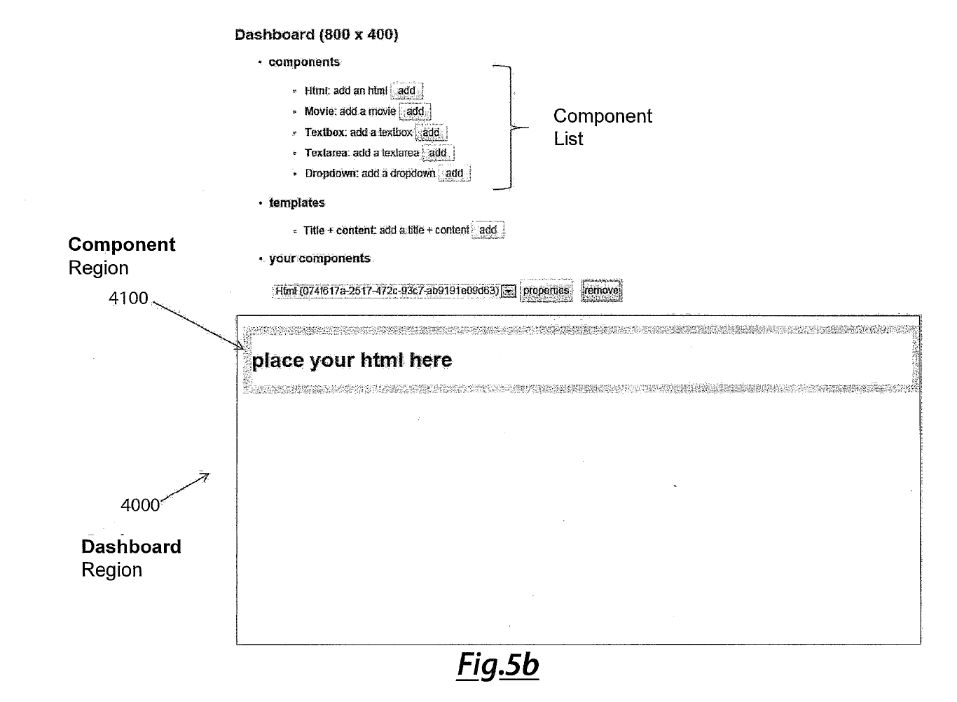

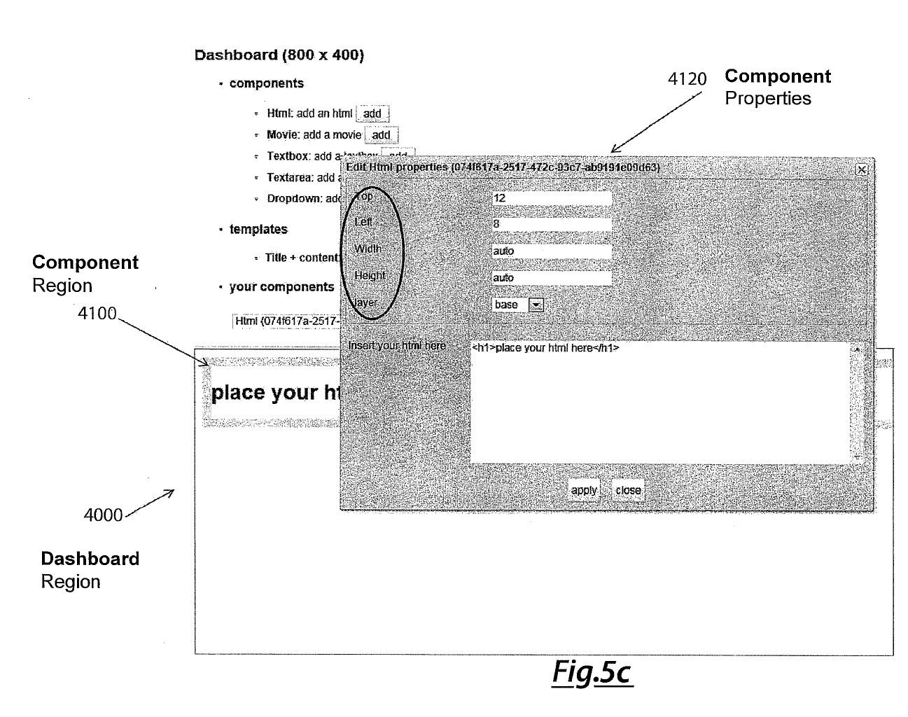

FIG. 5 schematically shows an interface of one of the two software modules of FIG. 4 in an initial step (FIG. 5a), a subsequent step (FIG. 5b), and a further subsequent step (FIG. 5c) of operation;

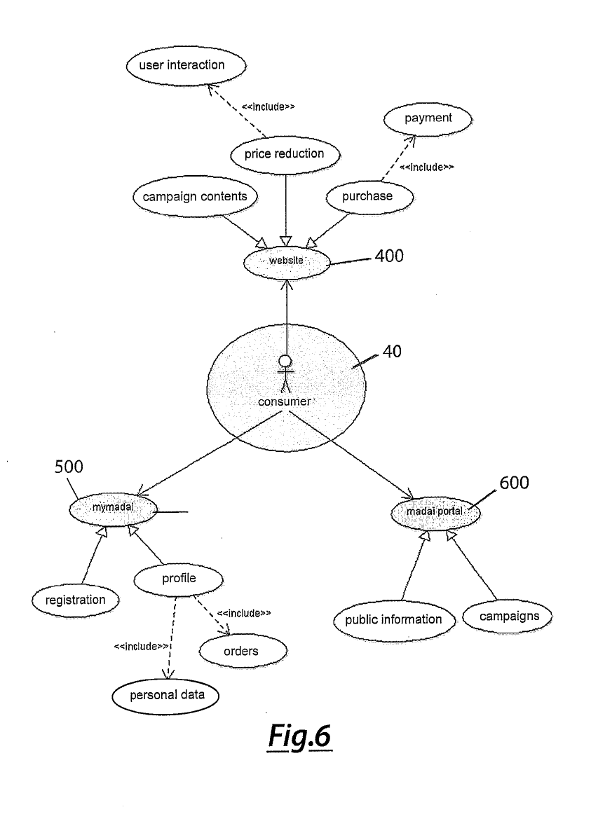

FIG. 6 shows a block diagram schematically illustrating further interactions among other three software modules executed by the system of FIG. 1;

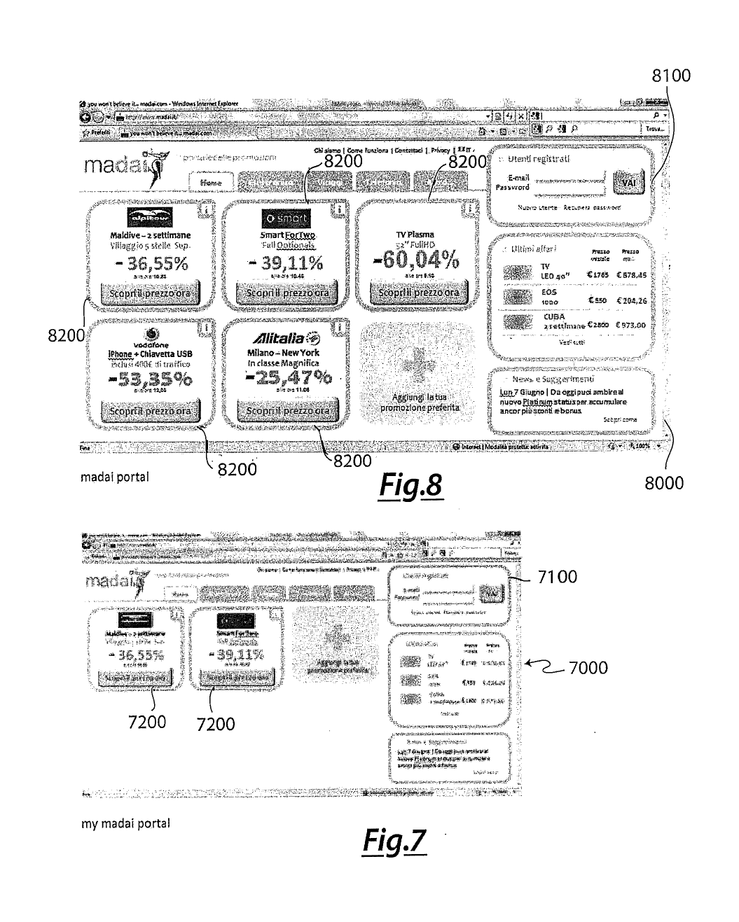

FIG. 7 schematically shows an interface of a first one of the three software modules of FIG. 6; and

FIG. 8 schematically shows an interface of a second one of the three software modules of FIG. 6.

With reference to FIG. 1, it is possible to observe that a preferred embodiment of the computer network system on which the electronic platform according to the invention is based comprises a main server computer 10 connected to a communication network 20, preferably comprising the Internet network, to which (at least) one computer 30 of (at least) one promoting company and a plurality of client computers 40, 50 and 60 of users are also connected. In particular, the computer 30 of the promoting company may advantageously be a client computer. A CDN (Content Delivery Network) sub-system 70 of server computers connected in a network for delivering multimedia contents (usually of large size) is also connected to the communication network 20; in particular, the network to which the server computers of the CDN sub-system 70 are connected may be the same communication network 20, preferably the Internet network. Finally, the server and client computers 10-70 of the computer network system according to the invention may be dynamically or stably connected through the communication network 20 to a plurality of external server computers of service providers associated with the electronic platform, such as for instance one or more server computers 80 providing services of cellular telephony messages (e.g. SMS and MMS), one or more server computers 81 providing electronic mail services, one or more server computers 82 providing services of Social Network and/or forum and/or blog, one or more server computers 83 providing payment services, and one or more server computers 84 providing other possible services (e.g. information services).

It should be noted that the main server computer 10 and the server computers of the CDN sub-system 70 may be also virtual servers, and that the services with which they provide the computers 30-60 may be services based on resources which are distributed and virtualised in a network according a so-called cloud computing infrastructure, still remaining within the scope of protection as defined by the attached claims.

It should be further noted that the computers 30-60 which are part of the platform, in particular the client computers 40-60 of the users, may be not necessarily PCs, but they can be any other client device provided with processing means, such as for instance cellular telephones, a smartphone or a television, always remaining within the scope of protection as defined by the attached claims.

In brief, a user accessing the web site of the promoting company may participate to a promotional campaign of the latter, wherein a product is offered at a progressively reduced price, that is reported within the graphic interface of a page (e.g. the entry page) of the web site of the promoting company through a graphic sub-interface (related to the promotional campaign in progress), in the following also called dashboard. Starting from such graphic sub-interface, the user may browse further graphic interfaces related to the promotional campaign in progress, as if he/she browsed a web site, and interacting with these graphic interfaces so as to make the sale price of the product reduce. In the following, the starting sub-interface and the subsequent graphic interfaces related to a promotional campaign will be also indicated as a whole as graphic interfaces of the promotional campaign site. Advantageously, the main server computer 10 may keep track of the previous browsings of a (client computer of a) user so that at each new browsing in the promotional campaign site new graphic interfaces which (the client computer of) the user has not yet visited are proposed.

The operation of the overall electronic platform according to the invention is based on three software modules executed by the main server computer 10: a first interface software module 100 (in the Figures also indicated as Cached Browser Based Interface or C2BI) that assigns part of the workload to the browsers of the users; a second software module 110 (in the Figures also indicated as Promotion Management System or PMS) for implementing, executing, and managing interactive graphic interfaces (in the Figures also indicated as Cached Browser Based Interface or C2BI); and a third software module 120 for processing the price of the products which are the subject of the promotional campaigns. Such three software modules and the interactive graphic interfaces will be illustrated in greater detail later.

The computers 30 of the promoting companies execute a fourth control software module 300 (in the Figures also indicated as “back office”) through which the promoting companies may manage the creation, publication, and administration of a promotional campaign. In particular, the fourth control software module 300 can be also a software module based on the web (i.e. a so-called web-based module).

In particular, making reference to FIG. 2, in the creation of a promotional campaign the staff 900 of a promoting company uses the fourth control software module 300 for implementing, through the second software module 110, the interactive graphic interfaces of the promotional campaign, providing them with multimedia contents retrieved from the CDN sub-system 70, such as html, textual, image, video, sound contents etc. To this end, through the fourth control software module 300, the promoting company 900 uses specific customised instruments 111 of interaction with the user of the second software module 110 for implementing in a simple and highly versatile way such interactive graphic interfaces of the promotional campaign, as it will be better illustrated later.

Each interactive graphic interface comprises one or more elements stimulating the users to interact through one or more components of the same interactive graphic interface, such as for instance:
an element comprising a textual question or statement soliciting the user to give a response or a comment that he/she may insert in a text area of the interactive graphic interface or which he/she may select through a control graphic component (e.g. radio button);
an element comprising a textual question or statement soliciting the user to give a multiple response or a plurality of permitted opinions and which he/she can also select through a control graphic component (e.g. checkbox);
an element comprising an image soliciting the user to give a single or multiple response that he/she can insert in a text area of the interactive graphic interface or that he/she can select through a control graphic component (e.g. radio button, checkbox);
an element comprising a video soliciting the user to give a comment on the video that he/she can insert in a text area of the interactive graphic interface;
an element comprising a text soliciting the user to give only an indication that it has been viewed/read, e.g. by selecting a control graphic component put at the end of the text;
an element comprising one or more multimedia contents, such as texts and/or videos and/or images and/or sounds, soliciting the user to view them, e.g. by preventing the browsing in the graphic interface from continuing before that a minimum time of enjoyment of said one or more multimedia contents has expired;
an element comprising a complex html document soliciting the user to give a single or multiple response that he/she can insert in a text area of the interactive graphic interface or that he/she can select through a control graphic component (e.g. radio button, checkbox);
an element comprising one or more multimedia contents, such as texts and/or videos and/or images and/or sounds, soliciting the user to give comments and information, e.g. through components into which biographical data have to be inserted (e.g. by making the enjoyment conditioned to the insertion of such data);
an element comprising a request soliciting the user to execute an activity, e.g. the purchase of a product, that the user may prove through a graphic component, e.g. a text area into which the code of a receipt or of the product has to be inserted;
an element combining the elements listed above, soliciting the user to interact through one or more of the aforementioned components.

In particular, at each interaction of a user, the price of the product that is the subject of the promotional campaign is reduced on the basis of the processing made by the third software module 120 executed by the main server computer 10, as it will be better illustrated later.

Always making reference to FIG. 2, in the publication of a promotional campaign the staff 900 of the promoting company uses the fourth control software module 300 for viewing a complete preview of the implemented promotional campaign and for generating and managing the scripts of this campaign which are used by the promoting company on its web site in order to show at least one static and/or dynamic graphic sub-interface, also called widget or dashboard, reporting some dynamic data of the promotional campaign in progress and which can then display, when the users whose browsers access the web site of the promoting company click on them, other graphic interfaces of the site of the promotional campaign of the promoting company.

By way of example, and not by way of limitation, FIG. 3 shows the graphic interface 3000 of a page (e.g. the entry page) of the web site of a promoting company within which the scripts generated and managed by the fourth control software module 300 show a graphic sub-interface 3100 related to the promotional campaign in progress (see FIG. 3a). The graphic sub-interface 3100 comprises an hypertextual element 3110, e.g. reporting the name of the promotional campaign and/or a product that is offered on sale and the price of which lowers after the interactions of the users (as it will be illustrated in greater detail later), and a field 3120 showing the current price of the product that is the subject of the promotional campaign. By clicking on the hypertextual element 3110, the user browser displays a graphic interface 3200 related to the promotional campaign, e.g. comprising a textual element 3210, a field 3120 showing the current price of the product, and an element 3230 comprising a video soliciting the user to view it for further making the product price lower (see FIG. 3b).

Still making reference to FIG. 2, in the administration of a promotional campaign the staff 900 of the promoting company uses the fourth control software module 300 for managing the sale orders received by the company for all the promotional campaigns. Also, it is possible to manage the multilanguage property of each promotional campaign: in this case, the staff 900 of the promoting company uses the fourth control software module 300 for making the promotional campaign available in several languages. Finally, the fourth control software module 300 also offers reporting and statistical activities, including graphic representations (e.g. pie ad bar charts) for analysing the data collected thanks to the interaction of the users who participate to the promotional campaigns published by the promoting company (e.g. how many users participate, how many participating users come from the web site of the promoting company, how many samples of the product that is the subject of the promotional campaign have been sold, etc.).

With reference to FIG. 4, the two software modules 100 and 110 executed by the main server computer 10 will be now illustrated.

As stated, the first interface software module 100 assigns part of the workload to the browser of the users, so as to distribute the workload over the client computers 40-60 of the users, so that the APIs (Application Programming Interface) of the main server computer 10 deliver solely data related to the current price of the product that is the subject of the promotional campaign. To this end, all the static data of all the graphic interfaces of the site of the promotional campaign (such as the sub-interface 3100 and the interface 3200 of FIG. 3), such as JavaScript libraries 700 used by the first software module 100, contents 710 in JSON format related to platform texts and their internationalisation, campaign contents and their internationalisation and contents related to the graphic interfaces of the site of the promotional campaign and their internationalisation are delivered by the CDN sub-system 70 and loaded by the web interface through tag scripts complying with the development technique for implementing interactive web applications called AJAX. In this regard, the JavaScript language is described, e.g., by D. Crockford in “JavaScript: The Good Parts-Unearthing the Excellence in JavaScript”, OR'Reilly Media/Yahoo Press, Released: May 2008; the JSON format (JavaScript Object Notation) is described, e.g., in the Internet site at the address www.json.org; and the AJAX technique is described, e.g., by N. C. Zakas, J. McPeak and J. Fawcett in “Professional Ajax, 2nd Edition (Programmer to Programmer)”, Wrox; 2nd edition, Mar. 12, 2007.

In this way, the electronic platform according to the invention is capable to exploit the mechanisms of temporary storage, also called caching, native of the browser of the client computers through which the users access the site of the promotional campaign for carrying out the load and management of the graphic interfaces of the site of the promotional campaign. Hence, the first interface software module 100 permits that the rendering of the graphic interfaces of the site of the promotional campaign occurs on the client computer (specifically the one indicated in FIG. 1 with the number 40) of a user accessing such interfaces for participating to the promotional campaign, and that the communication with the main server computer 10 is kept through AJAX calls with protocols based on the JSON format. This allows to have a fast responsivity of the graphic interfaces of the site of the promotional campaign and a minimisation of the bandwidth occupancy, although the electronic platform according to the invention is mainly based on the so-called pull technology, wherein the interactions are originated by the users participating to the promotional campaign, and the graphic interfaces of the site of the promotional campaign are reach, multi-browser and multi-context; also, this allows the main server computer 10 to update, upon the interactions of the users, the prices of the products which are the subject of the promotional campaigns in progress in real time, since most part of its resources are available for the execution of the instances of the third software module 120 for processing the price (one instance for each promotional campaign).

The second software module 110 for implementing, executing, and managing interactive graphic interfaces allows to organise the graphic interfaces of the site of the promotional campaign so as to request in a rapid and flexible way the user participating to the promotional campaign for any interactive behaviour. In particular, the implementation of the graphic interfaces of the site of the promotional campaign can be made starting from zero or also through templates.

In particular, the second software module 110 is substantially an instrument permitting the implementation, execution, and management of the interfaces of the site of the promotional campaign, in the following also called “graphic regions”. In the following the graphic regions contained within other graphic regions (i.e. sub-interfaces contained within other interfaces) are also called “graphic components”, while graphic regions which are not graphic components (i.e. interfaces not contained within other interfaces) are also called “dashboard”.

As schematically shown in FIG. 4, in order to obtain the maximum usability of the interface of the second software module 110 for managing the dashboards 4000, this interface supports the drag and drop of the graphic components 4100 (e.g. html fields and text fields) and of the graphic elements 4200 (e.g. video/audio fields and multiple response question fields) through the aid of the pointing device (or mouse). In order to obtain the maximum flexibility in defining the contents of a dashboard 4000, they are subdivided in graphic elements and positioned in an absolute way within the dashboard. The chosen implementation is based on an innovative and effective use of the standard CSS (Cascading Style Sheets) language, which language is described, for instance, in the web site at the address www.w3.org/TR/CSS/.

In particular, the second software module 110 requires that:
a dashboard 4000 is implemented with a tag div and the valorisation of its attribute style with a translation in terms of CSS rules of its property size (where size consists of a pair (width, height) of values capable to represent the width and height size of a region):

<!-- a dashboard with size = (100, 200) -->
<div style=“position:relative;width:100px;height:200px;”>
<!-- components... -->
</div>

where, for ensuring the relative positioning of the dashboard (e.g. with respect to the page of the web site of the promoting company into which it is inserted), the following CSS rule has been used:
   position:relative;
a graphic component is implemented with a tag div and the valorisation of its attribute style with a translation in terms of CSS rules of its property size and of its property position:

<!-- a component with size = (100, 200) and position = (0, 50) -->
<div style=“position:absolute;top:0px;left:50px;width:100px;-
height:200px;”>
<!-- component body... -->
</div>

where, for ensuring the absolute positioning of the graphic component, the following CSS rule has been used:
   position: absolute;
and the absolute positioning is defined by the pair (top, left) of values capable to represent the absolute position—specifically of the top left corner—of the graphic element with respect to the graphic region or graphic component that contains the same.

By way of example, and not by way of limitation, a dashboard having two components is defined by the second software module 110 as follows:

```
<!-- a dashboard with size = (400, 350) -->
<div style=“position:relative;width:100px;height:200px;”>
  <!-- a component with size = (100, 200) and position = (10, 50) -->
  <div style=“position:absolute;top:10px;left:50px;width:100px;-
  height:200px;”>
  html1...
  </div>
  <!-- a component with size = (70, 100) and position = (150, 200) -->
  <div style=“position:absolute;top:150px;left:200px;width:70px;-
  height:100px;”>
  html2...
  </div>
</div>
```

In other words, while the standard CSS language is presently used for defining the format of a web page, the second software module 110 uses the standard CSS language for describing the same contents of a graphic interface (or sub-interface).

As shown in FIG. 4, also the JavaScript libraries 720 used by the second software module 110 are delivered by the CDN sub-system 70. Once that the implementation of a dashboard through the second software module 110 is ended, the contents 710 (and their internationalisation) of the dashboard are stored in JSON format within the CDN sub-system 70, while the first interface software module 100 keeps information related to its retrieval within the CDN sub-system 70, which CDN sub-system 70 will deliver such contents each time that a user will access the dashboard 4000 through the browser of its client computer 40.

FIG. 5 shows the interface of the second software module 110 in three subsequent steps of implementation of a dashboard 4000 having a graphic component 4100 (univocally identified in the electronic platform according to the invention by the identification code “074f617a-2517-472c-93c7-ab9191e09d63”—see FIG. 5b and FIG. 5c) consisting in html content the properties (e.g. width, height, top, left) of which can be modified through a suitable window 4120, that may be opened in the interface of the second software module 110 (see FIG. 5c).

Making reference to FIGS. 1 and 6, it may be observed that the users may access the electronic platform according to the invention through three further software modules.

Through a fifth software module 400 for browsing (i.e. substantially consisting in a browser), in the Figures also indicated as “website”, that interacts with the first software module 100, the user may access the graphic interfaces of the site of the promotional campaign, for receiving its contents and executing the solicited interactions so as to contribute to the reduction of the price of the product that is the subject of the promotional campaign. Moreover, still through the fifth software module 400, during the activity of price reduction, the user may view the contents of the promotional campaign published by the promoting company (e.g. extended description of the product, terms of the campaign, sale conditions, etc.). Finally, when the price reached by the product and displayed in the graphic interfaces of the site of the promotional campaign is accepted by the user, the latter may purchase and pay the same product (possibly with the cooperation of an external server 83).

A sixth software module 500 for browsing (i.e. substantially consisting in a browser), in the Figures also indicated as “mymadai”, that interacts with the first software module 100, allows the creation and management of the user data of the consumers. In particular, as soon as the recording activity is achieved, preferably necessary in order that a user can be authorised to use the platform according to the invention, the user can manage his/her own profile modifying the personal data and controlling the status of the purchase orders which he/she has made during participation to one or more promotional campaigns. By way of example and not by way of limitation, FIG. 7 shows a graphic interface 7000, structured as a web page, displayed by the sixth software module 500, wherein in particular graphic elements 7100 for the insertion of data (email and password) of authentication of the user and some graphic elements 7200 providing information related to the promotional campaigns to which the user is participating are shown.

Making reference again to FIGS. 1 and 6, through a seventh software module 600 for browsing (i.e. substantially consisting in a browser), in the Figures also indicated as “madai portal”, that interacts with the first software module 100, the user may find a showcase of all the promotional campaigns active in that moment from different promoting companies on the platform according to the invention. In this way, the user may conduct researches among the promotional campaigns in progress by product category (e.g. consumer electronics, books, travels) or by promoting company and he/she may join the promotional campaigns which he/she deems interesting. Moreover, the seventh software module 600 provides (i.e. displays after the interaction with the first software module 100) a series of public information about the electronic platform according to the invention (e.g. explanations of the operation, privacy management, contacts, etc.). By way of example and not by way of limitation, FIG. 8 shows a graphic interface 8000, structured as a web page, displayed by the seventh software module 600, wherein, in particular, graphic elements 8100 for the insertion of data (email and password) for user's authentication and some graphic elements 8200 providing information related to the promotional campaigns in progress are shown.

Obviously, at least two of the browsing software modules 400, 500, and 600 may be coinciding in a sole browser software module (i.e. substantially consisting in a browser).

In order to better understand the electronic platform according to the invention, some modes of operation of the preferred embodiment are described in the following, similar modes being valid for the other embodiments.

After having accessed (in a safe way through authentication) the fourth software module 300, the staff of the promoting company may manage already active promotional campaigns in terms of orders to fulfil, reporting and data to download and analyse besides the generation/management of the scripts of the promotional campaigns.

Moreover, through the connection of the fourth software module 300 to the second software module 110, the staff of the promoting company may create a new promotional campaign with particular attention to the graphic interfaces of the site of the promotional campaign (e.g. the dashboards) into which he/she will insert different types of content organised according to the stimulus—interaction logic: where the stimulus may be any content customisable by the promoting company (e.g. images, texts, sounds, advanced html, inserts of dynamic code, videos, any combination of these elements, etc.) and the interaction may be a set of expected behaviours as simple or multiple responses, insertion and check of codes (e.g. of proofs of purchase), free expression of opinions, etc.

Always through the second software module 110, the staff of the promoting company may create, in support of the promotional campaign, also the page of information of the product that is the subject of the promotional campaign by loading and positioning several types of content (e.g. images, texts, advanced html, videos, etc.).

Through the fourth software module 300, the staff of the promoting company compiles a set of basic parameters necessary to the operation of a promotional campaign (e.g. product name, number of the samples on sale, etc.).

Still through the fourth software module 300 (specifically through one of its functions), the staff of the promoting company may view a preview of the just created promotional campaign.

Always through the fourth software module 300, the staff of the promoting company publishes the created promotional campaign; in such case, the fourth software module 300 executes several checks capable to ensure the presence of all the information that is mandatory in order to publish a campaign.

A user, through the sixth software module 500, that interacts with the first software module 100, may become aware of several campaigns from different promoters and he/she gets information about the operation of the electronic platform.

A user, through the seventh software module 600, that interacts with the first software module 100, may register the electronic platform, exploiting a multi-language graphic interface, for participating to the promotional campaigns.

Afterwards, through the fifth software module 400, that interacts with the first software module 100, the recorded user accesses in an authenticated way an active promotional campaign and he/she consults the information contents thereof.

Still through the fifth software module 400 (interacting with the first software module 100), the user may interact with the interfaces of the site of the promotional campaign, causing the price of the product that is the subject of the promotional campaign to reduce.

Always through the fifth software module 400 (interacting with the first software module 100), the user may purchase the product.

Through the seventh software module 600 l (interacting with the first software module 100), the user may manage, with regard to his/her own profile, the personal data and the status of the orders which appeared after the purchases he/she made.

With regard to the modes of decreasing the price of a product (and/or a service) that is the subject of a promotional campaign after the interactions of the users, it is possible to observe that, in the preferred embodiment, the third software module 120, preferably developed in Java, executes a price function dynamically processing the price in real time that permits to obtain in any instant the price reached by the product (and/or service) as a function of the interactions of the users and of parameters predefined by the promoting company.

Advantageously, for each promotional campaign a defined amount of samples of the same product is available for sale, which are available for purchase only one at a time. When a sample is purchased by a user, a new sample replaces the preceding one until the samples of the same product are sold out.

The price function is applied to each sample and determines the behaviour of the price with values ranging from the starting price and a minimum price (where the former is larger than the latter).

The price function returns the price of a sample for a specific user in a specific instant of the sample lifetime during the promotional campaign, i.e. between a purchase event and the subsequent one. Hence, since the price function is in general referred to a specific user, it follows that in general the users have the same sample that is offered with a different price to each specific user in the same instant.

The price function has some important features, besides that of determining the value ranging from the starting price to the minimum price in a specific instant for a user:
it is always decreasing for each user during the lifetime of the sample during the promotional campaign;
it may decrease on the basis of the interactions carried out by the single user, as a reward for a behaviour desired by the promoting company; e.g., if the user watches a video or respond to a question, he/she is rewarded with a decrease of the product price;
it may decrease on the basis of the interactions of all the users of a promotional campaign; in such case, the price for each single user can be affected to varying extents also by the interactions carried out by the community of users participating to that promotional campaign and the extent of such influence is given by the type of applied price function.

A first type of price function, in the following called “basic”, adjust the price in a uniform way for all the users, whereby each single user benefits from the interactions carried out by himself/herself and by the other users participating to the promotional campaign. In particular, when a user performs a desired behaviour, the “basic” price function starts from the lowest price reached by any other user in that campaign for that sample in that instant and it subtract a portion thereof corresponding to the interaction carried out by the user in that instant, also benefiting from the interactions previously carried out by all the other users. In other words, it is only when a user performs a desired behaviour, hence contributing to lowering the price, that he/she can in turn benefit from the interactions previously carried out by the community. On the contrary, if he/she does not contribute with an interaction, the user continues to see the price dating back to his/her last interaction, i.e. to his/her last contribution to lowering the price.

Other possible types of price functions may be generated by varying the influences and the characteristics of the interaction, users, community, time, products and product price variables. By way of example, and not by way of limitation, it is possible to generate price functions different from the basic one which exclude the community element, and which are hence based on the work of the single user, as well as price functions where the price automatically decreases as the permanence time of a sample in the campaign increases.

As stated, in each instant of the promotional campaign a user may purchase the available sample; and the campaign end when all the samples have been sold.

The preferred embodiments of this invention have been described and a number of variations have been suggested hereinbefore, but it should be understood that those skilled in the art can make other variations and changes, without so departing from the scope of protection thereof, as defined by the enclosed claims.

1-14. (canceled)

15. Computer network system comprising a main server computer comprising first processing means, that is connected to a first communication network to which a CDN (Content Delivery Network) sub-system of server computers, connected to each other in a network, is also connected for delivering multimedia contents, and a plurality of user client devices, each one of which comprises second processing means and communication means for connecting to the first communication network, said second processing means of each one of said user client devices being adapted to execute a first browser software module for browsing a web site, comprising temporary storage or caching mechanisms, wherein the first browser software module, when executed by said second processing means, is adapted to connect with a first interface software module executed by said first processing means for visiting at least one web site of at least one promotional campaign comprising one or more interactive graphic interfaces, each one of said one or more interactive graphic interfaces comprising static data including one or more of said multimedia contents, one or more graphic elements each capable to stimulate users by delivering at least one of said one or more multimedia contents, and one or more graphic components capable to receive one or more interactions from the users, at least one product being offered by said at least one web site of said at least one promotional campaign at a price that is reduced starting from a starting price after said one or more interactions by the users received by said one or more graphic components, the first interface software module causing said static data to be delivered to the first browser software module by the CDN sub-system and a rendering of said one or more interactive graphic interfaces to be carried out by the first browser software module through said caching mechanisms, said first processing means being adapted to execute a price function processing software module that processes a reduced price of said product on the basis of each one of said one or more interactions by the users received by said one or more graphic components.

16. System according to claim 15, wherein the first browser software module connects with the first interface software module through AJAX calls with protocols based on JSON format, said static data comprising data in JSON format.

17. System according to claim 15, wherein the communication network comprises the Internet network.

18. System according to claim 15, wherein each one of said user client devices is selected from the group comprising computers, cellular telephones, smartphones and televisions.

19. System according to claim 15, further comprising at least one device of at least one company promoting said at least one promotional campaign, said at least one device comprising third processing means and communication means for connecting to the first communication network, said first processing means being adapted to execute a second software module for implementing said one or more interactive graphic interfaces, said third processing means being adapted to execute a control software module, adapted to connect with the second software module for implementing said one or more interactive graphic interfaces, the static data of said one or more interactive graphic interfaces implemented by the control software module through the second software module being stored by the second software module within the CDN sub-system, the first interface software module keeping information related to retrieval of said static data of said interactive pages within the CDN sub-system.

20. System according to claim 15, wherein said second processing means of each one of said user client devices is adapted to execute a second browser software module for creating user data that, when executed by said second processing means, is adapted to connect with the first interface software module for creating at least one profile of recorded user for at least one promotional campaign, the first interface software module enabling the first browser software module to browse said at least one promotional campaign only if it recognises a profile of recorded user communicated by the first browser software module to the first interface software module.

21. Main server computer for use in a computer network system, the main server computer comprising first processing means and being configured to be connected to a first communication network to which a CDN (Content Delivery Network) sub-system of server computers, connected to each other in a network, is also connected for delivering multimedia contents, said first processing means executing a first interface software module that, when a first browser software module executed by second processing means of a user client device connected to the first communication network connects to the first interface software module for visiting at least one web site of at least one promotional campaign comprising one or more interactive graphic interfaces, causes static data of said one or more interactive graphic interfaces to be delivered to the first browser software module by the CDN sub-system and a rendering of said one or more interactive graphic interfaces to be carried out by the first browser software module through caching mechanisms, said first processing means being adapted to execute a price function processing software module that processes, on the basis of one or more interactions by users received by one or more graphic components of said one or more interactive graphic interfaces, a reduced price of at least one product offered by said at least one web site of said at least one promotional campaign starting from a starting price.

22. Main server computer according to claim 21, wherein said first processing means is adapted to execute a second software module for implementing said one or more interactive graphic interfaces when a control software module executed by third processing means of a device of at least one company promoting at least one promotional campaign connected to the first communication network connects to the second software module for implementing said one or more interactive graphic interfaces, the static data of said one or more interactive graphic interfaces implemented by the control software module through the second software module being stored by the second software module within the CDN sub-system, the first interface software module keeping information related to retrieval of said static data of said interactive pages within the CDN sub-system.

23. Method of operating a computer network system, wherein a main server computer and a CDN sub-system are connected to a first communication network, the method comprising the following steps:
A. at least one user client device connects to the first communication network,
B. said at least one user client device executes a first browser software module for browsing a web site, comprising caching mechanisms,
C. the main server computer executes a first interface software module,
D. the first browser software module connects to the first interface software module for visiting at least one web site of at least one promotional campaign comprising one or more interactive graphic interfaces, each one of said one or more interactive graphic interfaces comprising static data including one or more multimedia contents, one or more graphic elements each capable to stimulate users by delivering at least one of said one or more multimedia contents, and one or more graphic components capable to receive one or more interactions from the users, at least one product being offered by said at least one web site of said at least one promotional campaign,
E. the first interface software module causes the CDN sub-system to deliver said static data to the first browser software module,
F. the first interface software module causes the first browser software module to carry out a rendering of said one or more interactive graphic interfaces through said caching mechanisms,
G. the main server computer executes a price function processing software module that processes a reduced price of said product starting from a starting price on the basis of each one of said one or more interactions by the users received by said one or more graphic components.

24. Method according to claim 23, further comprising the following steps:
H. at least one device of at least one company promoting said at least one promotional campaign connects to the first communication network,
I. said at least one device executes a control software module,
J. the main server computer executes a second software module for implementing said one or more interactive graphic interfaces,
K. the control software module connects to the second software module for implementing said one or more interactive graphic interfaces,
L. the second software module stores the static data of said one or more interactive graphic interfaces implemented by the control software module through the second software module within the CDN sub-system,
M. the first interface software module keeps information related to retrieval of said static data of said interactive pages within the CDN sub-system.

25. System according to claim 16, wherein the CDN sub-system delivers to the first interface software module JavaScript libraries used by the first interface software module when the latter is operating.

26. System according to claim 17, wherein the network through which the server computers of the CDN sub-system are connected to each other is the Internet network.

27. System according to claim 19, wherein said at least one device is a client computer.

28. System according to claim 19, wherein the second software module for implementing said one or more interactive graphic interfaces comprises drag and drop mechanisms.

29. System according to claim 19, wherein the second software module implements each one of said one or more interactive graphic interfaces through the CSS (Cascading Style Sheets) language with which contents of said one or more interactive graphic interfaces are described.

30. System according to claim 19, wherein the static data of said one or more interactive graphic interfaces implemented by the control software module through the second software module are stored by the second software module within the CDN sub-system in JSON format.

31. System according to claim 19, wherein the CDN sub-system delivers to the second software module JavaScript libraries used by the second software module when the latter is operating.

32. System according to claim 20, wherein said at least one profile comprises authentication data.

33. System according to claim 20, wherein said second processing means of each one of said user client devices is adapted to execute a third browser software module for consulting said at least one promotional campaign that, when executed by said second processing means, is adapted to connect with the first interface software module for displaying information related to said at least one promotional campaign.

34. Main server computer according to claim 22, wherein the second software module for implementing said one or more interactive graphic interfaces comprises drag and drop mechanisms.

35. Main server computer according to claim 22, wherein the second software module implements each one of said one or more interactive graphic interfaces through the CSS (Cascading Style Sheets) language with which contents of said one or more interactive graphic interfaces are described.

36. Main server computer according to claim 22, wherein the static data of said one or more interactive graphic interfaces implemented by the control software module through the second software module are stored by the second software module within the CDN sub-system in JSON format.

37. Main server computer according to claim 22, wherein the CDN sub-system delivers to the first interface software module JavaScript libraries used by the first interface software module when the latter is operating.

38. Main server computer according to claim 22, wherein the CDN sub-system delivers to the second software module JavaScript libraries used by the second software module when the latter is operating.

39. Method according to claim 24, wherein the second software module for implementing said one or more interactive graphic interfaces comprises drag and drop mechanisms.

40. Method according to claim 24, wherein said one or more interactive graphic interfaces are implemented through the CSS (Cascading Style Sheets) language with which contents of said one or more interactive graphic interfaces are described.

41. Method according to claim 24, wherein in step L the second software module stores the static data of said one or more interactive graphic interfaces in JSON format.
